(19) United States
(12) Patent Application Publication
(10) Pub. No.: US 2025/0373968 A1
(43) Pub. Date: Dec. 4, 2025

(54) SOUND EMITTING APPARATUS AND ELECTRONIC KEYBOARD INSTRUMENT

(71) Applicant: CASIO COMPUTER CO., LTD., Tokyo (JP)

(72) Inventors: Yosuke NISHIMOTO, Tokyo (JP); Hiroki AKAI, Tokyo (JP); Manabu OOTAKE, Tokyo (JP); Yoshihiko SATO, Tokyo (JP)

(73) Assignee: CASIO COMPUTER CO., LTD., Tokyo (JP)

(21) Appl. No.: 19/224,062

(22) Filed: May 30, 2025

(30) Foreign Application Priority Data
May 31, 2024 (JP) 2024-088747

(51) Int. Cl. H04R 1/02; G10H 1/32

(52) U.S. Cl. CPC H04R 1/025; G10H 1/32; G10H 2220/221; G10H 2220/461

(57) ABSTRACT

A sound emitting apparatus includes a receiving frame in a shape of a box that open at a top and a sound emitting element disposed on the receiving frame and formed integrally, and the receiving frame and the sound emitting element together form a storage space for housing a speaker, an acoustic space connected to the storage space, and a duct connected to the storage space, and the acoustic space constitutes a space corresponding to an area including multiple lower bosses configured to fix the receiving frame and the sound emitting element together, provided to be aligned in a left-right direction, and protruding in an upward direction, and the receiving frame comprises a port that is open at a position corresponding to the duct.

### CROSS-REFERENCE TO RELATED APPLICATION

This application is based upon and claims the benefit of priority under 35 USC 119 of Japanese Patent Application No. 2024-088747 filed on May 31, 2024, the entire disclosure of which, including the specification, claims, drawings and abstract, is incorporated herein by reference in its entirety.

### BACKGROUND

### Technical Field

The present disclosure relates to a sound emitting apparatus and an electronic keyboard instrument.

### Description of the Related Art

There are demands for a reduction in size of a casing of an electronic keyboard instrument from a viewpoint of convenience, such as portability and storage. However, a reduction in size of a casing of an electronic keyboard instrument will cause a risk of the tone of a sound in a low-pitched sound range being deteriorated as a result of interference of a sound emitted from a rear surface (a back surface) of a vibration element of a speaker with a sound emitted from a front surface (a frontal surface) of the vibration element of the speaker. Then, Japanese Utility Model Laid-Open No. 6-26386 (JP-UM-A-6-26386) discloses a technique for preventing the deterioration of the tone of a sound in the low-pitched sound range even in the case that the size of the casing of the electronic keyboard instrument is reduced.

### SUMMARY

According to an aspect of the present disclosure, there is provided a sound emitting apparatus including a receiving frame in a shape of a box that is open at a top and a sound emitting element disposed on the receiving frame and formed integrally, wherein the receiving frame and the sound emitting element together form a storage space for housing a speaker, an acoustic space connected to the storage space, and a duct connected to the storage space, wherein the acoustic space constitutes a space corresponding to an area including multiple lower bosses configured to fix the receiving frame and the sound emitting element together, provided to be aligned in a left-right direction, and protruding in an upward direction, and wherein the receiving frame comprises a port that is open at a position corresponding to the duct.

### BRIEF DESCRIPTION OF THE DRAWINGS

FIG. 1 is a perspective view of an electronic keyboard instrument according to an embodiment of the present disclosure;

FIG. 2 is an exploded perspective view of the electronic keyboard instrument according to the embodiment as being disassembled into an upper case and a lower case;

FIG. 3 is a sectional view of the electronic keyboard instrument taken along a line III-III shown in FIG. 2;

FIG. 4 is an exploded view of a sound emitting apparatus positioned on the left side of FIG. 3 as being disassembled into a sound emitting element, a speaker, and a receiving frame;

FIG. 5 is an exploded perspective view of the sound emitting apparatus positioned on the left side of FIG. 3 as being disassembled into the sound emitting element and the receiving frame;

FIG. 6A is a top view of the sound emitting element shown in FIG. 4 with the speaker removed from the sound emitting element;

FIG. 6B is a bottom view of the sound emitting element shown in FIG. 4 with the speaker removed from the sound emitting element;

FIG. 7 is a top view of a part of the lower case of the sound emitting apparatus positioned in a left rear portion of the electronic keyboard instrument according to the embodiment with the sound emitting element removed from the sound emitting apparatus;

FIG. 8 is a sectional view taken along a line VIII-VIII shown in FIG. 7;

FIG. 9 is an enlarged view of a portion of the left side of the sectional view shown in FIG. 3; and

FIG. 10 is a bottom view of the electronic keyboard instrument according to the embodiment.

### DESCRIPTION OF THE EMBODIMENT

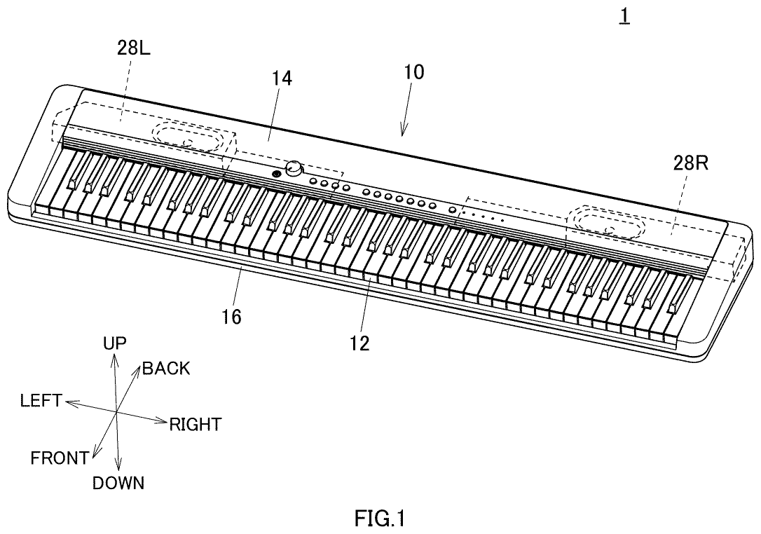

Hereinafter, referring to FIGS. 1 to 10, a structure of an electronic keyboard instrument 1 according to an embodiment of the present disclosure will be described. The electronic keyboard instrument 1 shown in FIG. 1 includes a casing 10 and a keyboard 12 which has multiple keys aligned in a longitudinal direction of the casing 10. The electronic keyboard instrument 12 has sound emitting apparatus 28L, 28R in an interior of the casing 10. Then, sounds are emitted from the sound emitting apparatus 28L, 28R as a player operates the keyboard 12. Here, in the following description, as shown in FIG. 1, a direction in which the keys of the keyboard 12 are aligned is defined as a left-right direction (in FIG. 1, a left-hand side is referred to as a leftward direction), and a direction in which the keys of the keyboard 12 extend is defined as a front-back direction (in FIG. 1, a front side is referred to as a forward direction). The left-right direction and the front-back direction are at right angles to each other. A direction which is at right angles to the left-right direction and the front-back direction is defined as an up-down direction (in FIG. 1, an upper side is referred to as an upward direction). In addition, the sound emitting apparatus 28L positioned at a left end portion of the electronic keyboard instrument 1 is configured to emit sounds in a low-pitched sound range, whereas the sound emitting apparatus 28R positioned at a right end portion of the electronic keyboard instrument 1 is configured to emit sounds in a high-pitched sound range. In the following description, the sound emitting apparatus 28L configured to emit sounds in the low-pitched sound range will be described in detail, whereas the description and illustration of the sound emitting apparatus 28R may be omitted from time to time. Respective structures of the sound emitting apparatus 28L, 28R which are included in the electronic keyboard instrument 1 are generally laterally symmetrical to each other with respect to a center of the electronic keyboard instrument 1 in a left-right direction thereof.

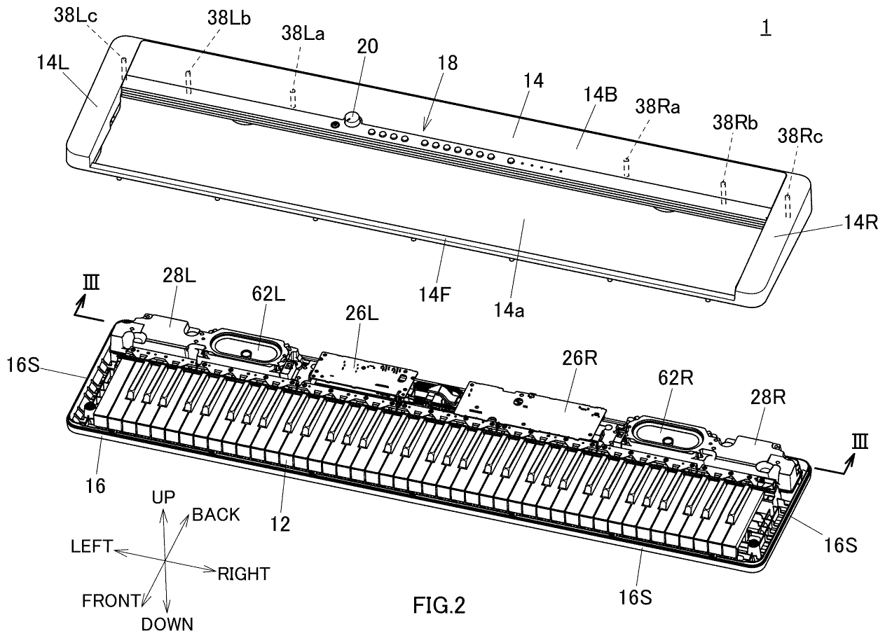

As shown in FIG. 1, when viewed from above, the casing 10 has a substantially elongated rectangular shape of which a longitudinal direction follows the left-right direction. The casing 10 is divided into an upper case 14 and a lower case 16 as shown in FIG. 2. The upper case 14 and the lower case 16 are each formed from a resin material.

When viewed from above, the upper case 14 has a substantially elongated rectangular shape and includes a hollow part 14a into which the keyboard 12 is fitted. The upper case 14 includes a left part 14L, a right part 14R, a front part 14F, and a back part 14B. The left part 14L and the right part 14R each extend in the front-back direction and have a substantially rectangular parallelepiped shape with an open bottom. The back part 14B extends in the left-right direction into a substantially rectangular parallelepiped shape with an open bottom. A left end face of the back part 14B connects to a back portion of a right side surface of the left part 14L. A right end face of the back part 14B connects to a back portion of a left side surface of the right part 14R. An upper surface of the back part 14B, an upper surface of the left part 14L, and an upper surface of the right part 14R slightly slope down from the back towards the front. Control switches 18 including a power switch are aligned in the left-right direction over a central front portion of the upper surface of the back part 14B. A volume dial 20 is provided on a left side of the control switches 18. Speaker grilles (not shown) are provided in a leftward portion and a rightward portion of the upper surface of the back part 14B in such a manner as to correspond respectively to speakers 62L, 62R, which will be described later. The front part 14F includes an upper main surface and a lower main surface and extends in the left-right direction into a plate-like shape. A left end of the front part 14F connects to a front end portion of the right side surface of the left part 14L. A right end of the front part 14F connects to a front end portion of the left side surface of the right part 14R. Lower surfaces of the left part 14L, the right part 14R, and the back part 14B are positioned to be level with the lower main surface of the front part 14F.

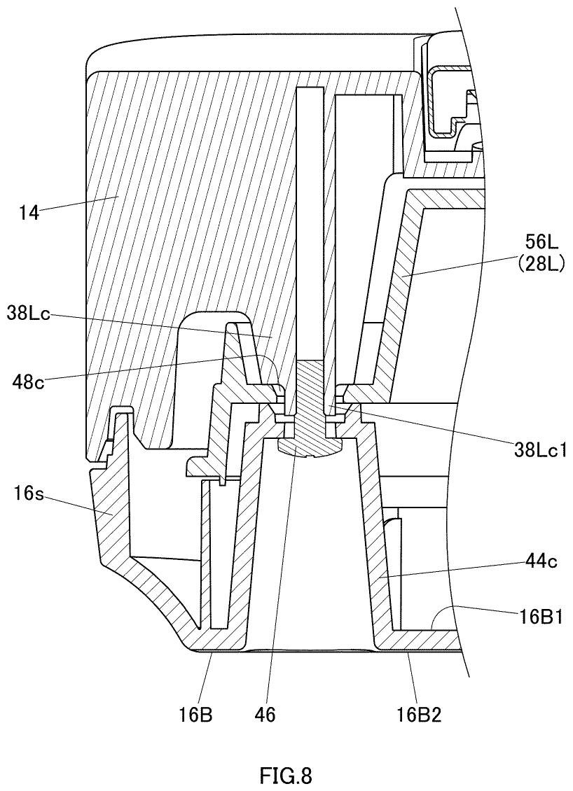

Upper bosses 38La, 38Lb, 38Lc are provided over a leftward portion of the back part 14B as shown in FIG. 2 in order to fix the upper case 14, the lower case 16, and the sound emitting apparatus 28L together. The upper bosses 38La, 38Lb, 38Lc protrude in the downward direction from an interior side of the back part 14B and each have substantially the shape of a frustum of circular cone which tapers off in the downward direction. The upper bosses 38La, 38Lb, 38Lc each have a hollow section for screw engagement with a fixing screw 46. To describe this in greater detail, as shown in FIG. 8, an outer edge of a lower end portion of the upper boss 38Lc is cut annularly, whereby a protrusion 38Lcl is formed at the lower end portion. The upper bosses 38La, 38Lb have the same shape as that of the upper boss 38Lc. The upper boss 38Lc is positioned in such a manner as to correspond to a case fixing hole 48c in an acoustic section 56L, which will be described later, and a lower boss 44c, which will be described later. The upper bosses 38La, 38Lb are positioned in such a manner as to correspond respectively to case fixing holes 48a, 48b in a storage section 54L, which will be described later, and lower bosses 44a, 44b, which will be described later. Upper bosses 38Ra, 38Rb, 38Rc are provided over a rightward portion of the back part 14B in order to fix the upper case 14, the lower case 16, and the sound emitting apparatus 28R together. Respective shapes and positions of the upper bosses 38Ra, 38Rb, 38Rc are similar to those of the upper bosses 38La, 38Lb, 38Lc, and hence, the description of the upper bosses 38Ra, 38Rb, 38Rc will be omitted here.

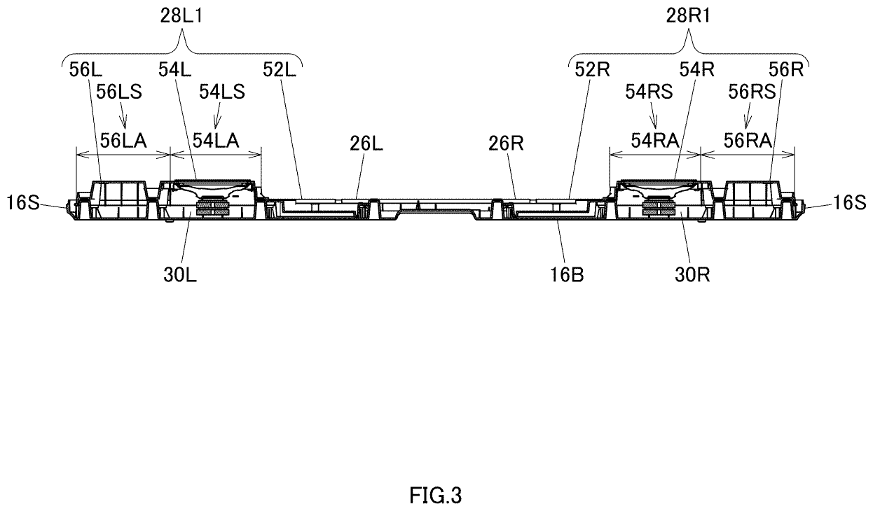

As shown in FIGS. 2 and 3, when viewed from above, the lower case 16 has a substantially elongated rectangular bottom surface 16B which extends in the left-right direction and a side surface 16S which extends in the upward direction from an outer edge of the bottom surface 16B. A boundary between the bottom surface 16B and the side surface 16S is rounded. An upper end of the side surface 16S is fitted in a lower end of the upper case 14, whereby the upper case 14 and the lower case 16 are integrated into a single unit.

As shown in FIGS. 2 and 3, the keyboard 12, control circuit boards 26L, 26R, and the sound emitting apparatus 28L, 28R are provided inside the lower case 16. The keyboard 12 is positioned in a front part of the lower case 16. The sound emitting apparatus 28L, 28R are positioned respectively in a left back corner and a right back corner of the lower case 16. The sound emitting apparatus 28L includes a sound emitting element 28L1 and a receiving frame 30L. The sound emitting element 28L1 and the receiving frame 30L are joined together in such a manner as to produce no gap therebetween. The sound emitting apparatus 28R includes a sound emitting element 28R1 and a receiving frame 30R. The sound emitting element 28R1 and the receiving frame 30R are joined together in such a manner as to produce no gap therebetween. The control circuit boards 26L, 26R are aligned sequentially from the left to the right in this order between the sound emitting apparatus 28L and the sound emitting apparatus 28R. A known key press mechanism is provided in a space defined between the keyboard 12 and the lower case 16 in order to realize a key press feeling close to that of a real piano when the keys of the keyboard 12 are pressed by the player.

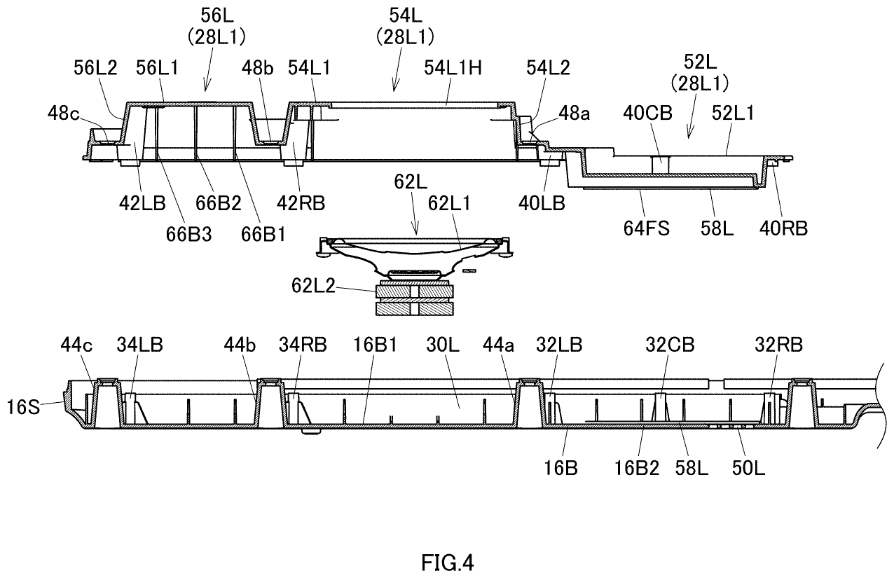

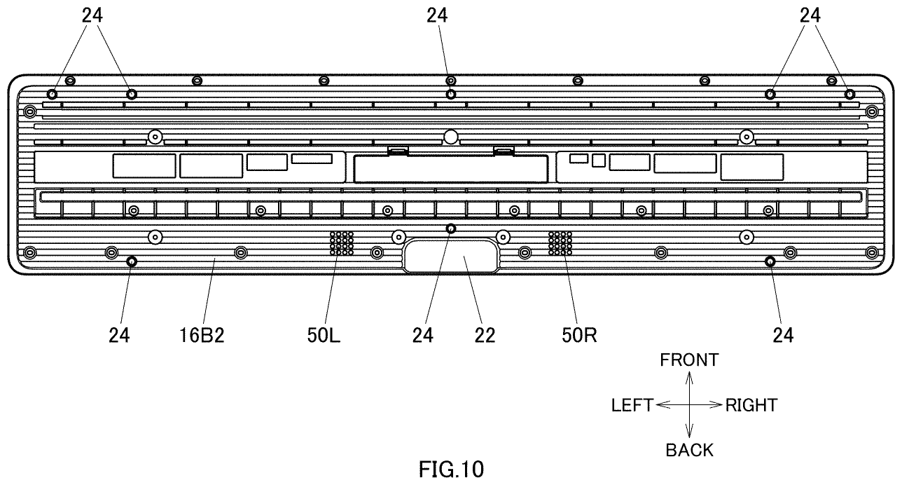

As shown in FIG. 4, the bottom surface 16B has an upper main surface 16B1 and a lower main surface 16B2. As shown in FIG. 10, a grip 22, rubber legs 24, and ports 50R, 50L, which will be descried later, are provided in and on the lower main surface 16B2. The grip 22 is positioned at a backmost central portion of the lower main surface 16B2. When viewed from below, the grip 22 has a substantially elongated rectangular shape of which a longitudinal direction follows the left-right direction and is recessed. The rubber legs 24 each have a substantially flat cylindrical shape and protrude in the downward direction. The rubber legs 24 are multiple and are disposed substantially at equal intervals along a front edge and a back edge of the lower main surface 16B2. The rubber legs 24 are in contact with a resting plane (not shown) to support the casing 10. Thus, a space is produced between the lower main surface 16B2 and the resting plane. The ports 50R, 50L are positioned laterally symmetrically with respect to the grip 22.

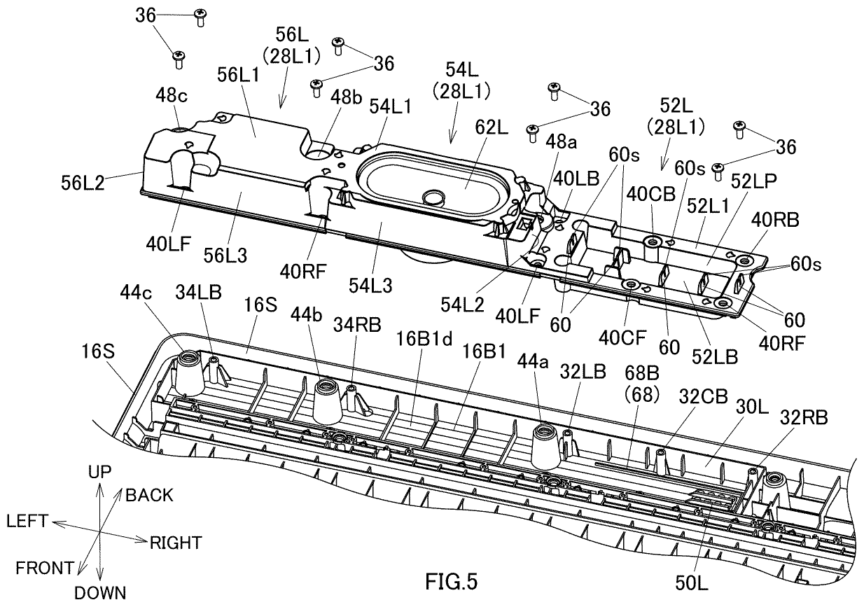

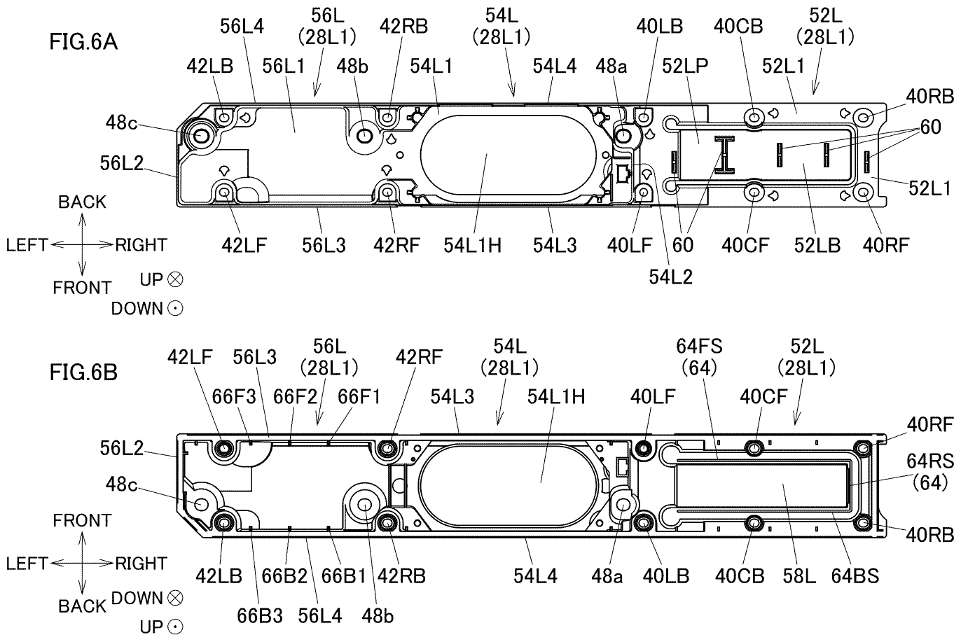

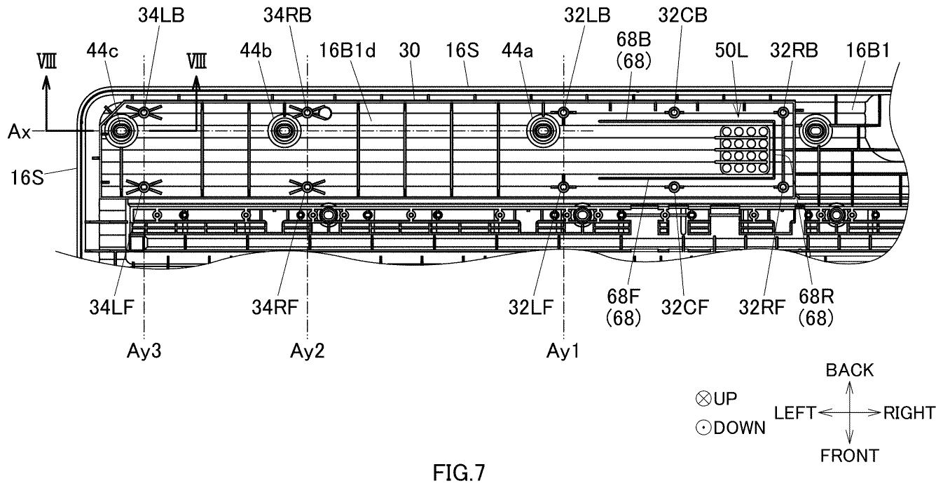

As shown in FIGS. 3 to 5, the receiving frame 30L is provided in a left upper corner of the upper main surface 16B1, so that the sound emitting element 28L1 is rested to be fixed thereto with no gap defined therebetween. The receiving frame 30L has a box shape and is open at the top. Specifically speaking, the receiving frame 30L is made up of a board-like component which rises up from the upper main surface 16B1 and the upper main surface 16B1 which is surrounded by this board-like component and has a substantially elongated rectangular shape of which a longitudinal direction follows the left-right direction when viewed from above. Multiple U-shaped grooves 16B1d, which extend in the left-right direction, are provided in the upper main surface 16B1. The U-shaped grooves 16B1d are formed in such a manner as to be recessed in the downward direction into a U shape. To describe this in greater detail, a cross-section of the U-shaped groove 16Bd which is at right angles to the left-right direction forms a shape which is recessed in the downward direction into an arc. Further, a duct rib 68 is provided on the upper main surface 16B1 in such a manner as to protrude slightly in the upward direction. The duct rib 68 includes a right rib 68R, a front rib 68F, and a back rib 68B and has a substantially U-like shape which is open at a left end when viewed from above. The duct rib 68 is positioned in such a manner as to correspond to a surrounding wall 64, which will be described later. The port 50L, which will be described later, is positioned at a right end of an interior of the duct rib 68. As shown in FIGS. 5 and 7, standing holes 32LF, 32 LB, 32RF, 32RB, 32CF, 32CB, 34LF, 34LB, 34RF, 34RB are provided inside the receiving frame 30L in order to fix the sound emitting element 28L1 in position. The standing holes 32LF, 32LB, 32RF, 32RB, 32CF, 32CB, 34LF, 34LB, 34RF, 34RB protrude in the upward direction from the upper main surface 16B1 into a cylindrical shape and each have a hollow section for screw engagement with an attachment screw 36. To describe this in greater detail, as shown in FIGS. 6A, 6B, the standing holes 32LF, 32LB, 32RF, 32RB, 32CF, 32CB are positioned in such a manner as to correspond respectively to attachment holes 40LF, 40LB, 40RF, 40RB, 40CF, 40CB in a port connecting section 52L, which will be described later. The 34LF, 34LB, 34RF, 34RB are positioned in such a manner as to correspond respectively to attachment holes 42LF, 42LB, 42RF, 42RB in the acoustic section 56L, which will be described later.

Further, as shown in FIG. 5, the lower bosses 44a, 44b, 44c are provided inside the receiving frame 30L in order to fix the upper case 14, the lower case 16, and the sound emitting apparatus 28L together. Specifically speaking, the lower bosses 44a, 44b, 44c fix the receiving frame 30L and the sound emitting element 28L1 together. The lower bosses 44a, 44b, 44c protrude in the upward direction from the upper main surface 16B1 and each have substantially the shape of a frustum of circular cone which tapers off in the upward direction. Additionally, the lower bosses 44a, 44b, 44c each have a hollow section through which a fixing screw 46 is passed as shown in FIG. 8. An outer edge of an upper end portion of each of the lower bosses 44a, 44b, 44c is cut annularly.

The lower boss 44a is positioned in such a manner as to correspond to the upper boss 38a and the case fixing hole 48a in the storage section 54L, which will be described later. The lower bosses 44b, 44c are positioned in such a manner as to correspond to the acoustic section 56L. To be more specific, the lower bosses 44b, 44c are positioned in such a manner as to correspond respectively to the upper bosses 38Lb, 38Lc and the case attachment holes 48b, 48c in the acoustic section 56L, which will be described later. The upper case 14, the lower case 16, and the sound emitting apparatus 28L can be fixed together more strongly and rigidly to the acoustic section 56L which is expanded in the left-right direction with the lower bosses 44b, 44c. In addition, the lower bosses 44a, 44b, 44c are aligned sequentially from the right to the left in this order on a longitudinal axis Ax as shown in FIG. 7. As a result of this, in a step of fixing the upper case 14, the sound emitting element 28L1, the receiving frame 30L, and the lower case 16 together with fixing screws 46, a working person is allowed to insert and pass the fixing screws 46 through the corresponding lower bosses 44a, 44b, 44c easily, whereby the working efficiency is improved.

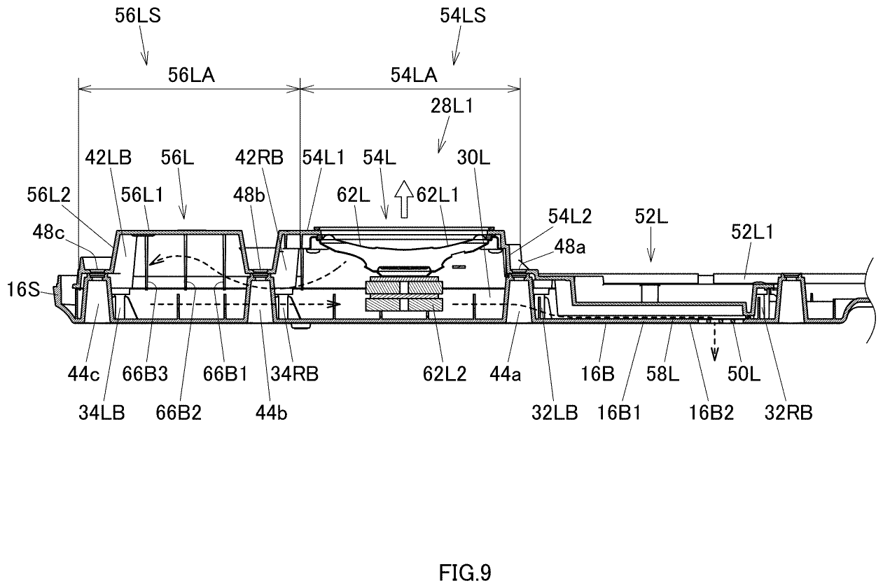

As shown in FIG. 7, the lower boss 44a is provided in the vicinity of the standing hole 32LB positioned at a back end so that the lower boss 44a is prevented from being brought into contact with a transverse axis Ay1 which connects the standing hole 32LF and the standing hole 32LB and can avoid a transverse central portion of the receiving frame 30L. This configuration makes it difficult for a communication between a storage area 54LA (refer to FIG. 9), which will be described later, and a duct 58L to be blocked. In other words, vibrations of air can be transmitted smoothly from the storage area 54LA to the duct 58L.

The lower boss 44b is provided in the vicinity of the standing hole 34RB positioned at the back end so that the lower boss 44b is prevented from being brought into contact with a transverse axis Ay2 which connects the standing hole 34RF and the standing hole 34RB and can avoid the transverse central portion of the receiving frame 30L. This configuration makes it difficult for a communication between an acoustic area 56LA, which will be described later, and the storage area 54LA. In other words, vibrations of air can be transmitted smoothly between the acoustic area 56LA and the storage area 54LA.

As shown in FIG. 8, the fixing screw 46 which is passed through the hollow section of the lower boss 44c from below is brought into screw engagement with the hollow section of the upper boss 38Lc via the case fixing hole 48c, which will be described later. As a result, the upper case 14 and the lower case 16 are fixed together with the sound emitting apparatus 28L held between the upper case 14 and the lower case 16. Specifically speaking, the lower boss 44c fixes the receiving frame 30L and the acoustic section 56L to each other. To describe this in greater detail, with the protrusion 38Lcl of the upper boss 38Lc fitted in the hollow section of the lower boss 44c via the case fixing hole 48c, the upper case 14, the sound emitting apparatus 28L, and the lower case 16 are fixed together or are integrated into a single unit with the fixing screw 46. Similarly, the fixing screw 46 which is passed through the hollow section of the lower boss 44a from below is brought into screw engagement with the hollow section of the upper boss 38La via the case fixing hole 48a. The fixing screw 46 which is passed through the hollow section of the lower boss 44b from below is brought into screw engagement with the hollow section of the upper boss 38Lb via the case fixing hole 48b.

The port 50L is provided at a rightward portion inside the receiving frame 30L. The storage area 54LA is interposed between the port 50L and the acoustic area 56LA, which will be described later. As a result of this configuration, the port 50L is positioned away from the acoustic area 56LA. Multiple circular holes are disposed in the port 50L in a matrix configuration in such a manner as to penetrate the bottom surface 16B in the up-down direction.

As shown in FIGS. 5 and 6A, 6B, the sound emitting elements 28L1, 28R1 each have a substantially elongated rectangular shape of which a longitudinal direction follows the left-right direction when viewed from above. The sound emitting element 28L1 is attached to the receiving frame 30L which is provided to rise in the left upper corner of the upper main surface 16B1. The sound emitting element 28L1 includes the port connecting section 52L, the storage section 54L, and the acoustic section 56L. The port connecting section 52L, the storage section 54L, and the acoustic section 56L are formed integrally into a single unit. That is, the port connecting section 52L, the storage section 54L, and the acoustic section 56L are formed from the same material seamlessly without being joined together and are aligned sequentially from the right to the left in this order to thereby form the sound emitting element 28L1. The sound emitting element 28R1 is attached to the receiving frame 30R which is provided to rise in a right upper corner of the upper main surface 16B1. The sound emitting element 28R1 includes a port connecting section 52R, a storage section 54R, and an acoustic section 56R. The port connecting section 52R, the storage section 54R, and the acoustic section 56R are formed integrally into a single unit and are aligned sequentially from the left to the right in this order to thereby form the sound emitting element 28R1.

As shown in FIGS. 6A, 6B, when viewed from above, the port connecting section 52L includes an upper surface 52L1 having a substantially elongated rectangular shape of which a longitudinal direction follows the left-right direction, a substantially rectangular parallelepiped pit 52LP which is recessed in the downward direction from an inside of the upper surface 52L1, and the surrounding wall 64. To describe this in greater detail, the pit 52LP includes a bottom surface 52LB having a left short side, a right short side, a front long side, and a back long side, and a left side surface, a right side surface, a front side surface, and a back side surface which extend in the upward direction from the corresponding sides of the bottom surface 52LB. As a result, a cross-sectional shape of the port connecting section 52L which is at right angles to the left-right direction forms a concave shape. Six attachment holes 40LF, 40LB, 40RF, 40RB, 40CF, 40CB are provided in the upper surface 52L1 in such a manner as to penetrate the upper surface 52L1 in the up-down direction. The attachment hole 40LF, the attachment hole 40LB, the attachment hole 40RF, and the attachment hole 40RB are positioned respectively in a left front corner, a left back corner, a right front corner, and a right back corner of the upper surface 52L1. The attachment hole 40CF is positioned substantially centrally between the attachment hole 40LF and the attachment hole 40RF, and the attachment hole 40CB is positioned substantially centrally between the attachment hole 40LB and the attachment hole 40RB. As shown in FIG. 5, attachment screws 36 which are inserted into the attachment holes 40LF, 40LB, 40RF, 40RB, 40CF, 40CB from above are brought into screw engagement respectively with the standing holes 32LF, 32LB, 32RF, 32RB, 32CF, 32CB which are provided in the receiving frame 30L. As a result, the port connecting section 52L is attached to the receiving frame 30L. To be more specific, a lower side of an outer edge of the upper surface 52L1 is rested to be fixed to an upper end of the receiving frame 30L. An elastic seal material is affixed to a joint plane between the lower portion of the outer edge of the upper surface 52L1 and the upper end of the receiving frame 30L. A space defined by the port connecting section 52L and the receiving frame 30L is tightly closed all around except for surfaces through which the space communicates with the port 50L and the storage area 54LA, which will be described later, positioned at a left end of the port connecting section 52L. The pit 52LP is housed inside the receiving frame 30L. In addition, the control circuit board 26L is rested on the port connecting section 52L. The control circuit board 26L outputs electric signals to the speaker 62L in response to inputs from the keyboard 12 when the keyboard 12 is operated by the player.

The port connecting section 52L includes multiple wiring clips 60. The wiring clip 60 is a plate-like component having a left main surface and a right main surface and protruding in the upward direction. A downward notch 60S is provided in an upper end of the wiring clip 60 in a central position in the front-back direction. To describe this in greater detail, as shown in FIGS. 5 and 6A, viewing the port connecting section 52L from above, five wiring clips 60 are disposed at substantially equal intervals in the left-right direction at a center of the port connecting section 52L in the front-back direction. Three of the five wiring clips 60 are positioned on the bottom surface 52LB. Two of the five wiring clips 60 are positioned individually at a left end portion and a right end portion of the upper surface 52L1. A wire (not shown) connecting the speaker 62L, which will be described later, and the control circuit board 26L is held in the notches 60S. As a result, an interference of the wire with the upper case 14, the keyboard 12, or the like is suppressed.

As shown in FIG. 6B, the surrounding wall 64 protrudes in the downward direction from an outside of the bottom surface 52LB. To describe this in greater detail, the surrounding wall 64 protrudes in the downward direction along an outer edge (the right short side, the front long side, the back long side) of the bottom surface 52LB. As a result, the surrounding wall 64 includes a right wall part 64RS, a front wall part 64FS, and a back wall part 64BS and has a substantially U-like shape which is open at a left end thereof when viewed from below. An elastic seal material is affixed to lower ends of the right wall part 64RS, the front wall part 64FS, and the back wall part 64BS. Then, the surrounding wall 64 is joined to the duct rib 68 to thereby define the duct 58L. The duct 58L has a flat cylindrical shape which extends in the left-right direction and is open at a left end thereof. Specifically speaking, the lower ends of the right wall part 64RS, the front wall part 64FS, and the back wall part 64BS are joined respectively to upper ends of the right rib 68R, the front rib 68F, and the back rib 68B to thereby define the duct 58L. Thus, the duct 58L is made up of the surrounding wall 64 and the duct rib 68. In other words, the duct 58L is positioned further downwards than lower ends (open lower surfaces) of the storage section 54L and the acoustic section 56L, both of which will be described later. A part of the duct 58 is formed by a part of the sound emitting element 28L1. The port 50L is positioned at a right end of an interior of the duct 58L. In other words, the duct 58L includes the port 50L which is open in the downward direction at an opposite end to an end thereof where the duct 58L connects to the storage area 54LA, which will be described later. The duct 58L defines a space which is tightly closed all around except for a portion where the port 50L is provided and an opening at the left end thereof.

The storage section 54L has a box shape which is open in a lower surface and a left surface thereof. To describe this in greater detail, when viewed from above, the storage section 54L includes a substantially elongated rectangular upper surface 54L1 having a right short side, a front long side, and a back long side, as well as a right side surface 54L2, a front side surface 54L3, and a back side surface 54L4 which extend in the downward direction from the corresponding sides of the upper surface 54L1. A lower end of the right side surface 54L2 of the storage section 54L connects to a left end of the upper surface 52L1 of the port connecting section 52L. The storage section 54L is rested to be fixed to the receiving frame 30L. To be more specific, lower ends of the front side surface 54L3 and the back side surface 54L4 of the storage section 54L are joined to the upper end of the receiving frame 30L. Thus, the storage area 54LA is formed as a result of being surrounded by the upper surface 54L1, the right side surface 54L2, the front side surface 54L3, the back side surface 54L4 of the storage section 54L, and the receiving frame 30L. An elastic seal material is affixed to a joint plane between the lower ends of the front side surface 54L3 and the back side surface 54L4 and the upper end of the receiving frame 30L. As a result, the storage area 54LA is tightly closed all around except for a surface through which the storage area 54LA communicates with the duct 58L positioned at a right end thereof and a surface through which the storage area 54LA communicates with the acoustic area 56LA, which will be described later, positioned at a left end thereof. An opening in the duct 58L is positioned in the vicinity of a right lower portion of the storage area 54LA. As a result, the duct 58L connects the storage area 54LA and the port 50L. The storage area 54LA communicates with an outside of the lower case 16 via the duct 58L and the port 50L.

The storage section 54L houses the speaker 62L inside the storage area 54LA. As a result, a storage space 54LS for housing the speaker 62L is defined in such a manner as to correspond to the storage area 54LA by the storage section 54L being rested on the receiving frame 30L. The speaker 62L is made up of a vibration element 62L1, a magnet 62L2, and a voice coil (not shown). The vibration element 62L1 has the shape of a frustum of circular cone having an upper surface, a lower surface, an inner surface, and an outer surface and tapers off from the top to the bottom. The vibration element 62L1 is open in the upper surface, and the upper surface is defined by a boundary between the inner surface and the outer surface. When viewed from above, the upper surface of the vibration element 62L1 has a substantially elongated rectangular shape of which a longitudinal direction follows the left-right direction and also has arcs resulting from an outward expansion of a left side and a right side. The magnet 62L2 has a flat cylindrical shape having an upper surface and a lower surface which are at right angles to each other in the up-down direction. The upper surface of the magnet 62L is in contact with the lower surface of the vibration element 62L1. When viewed from above, a center of the vibration element 62L1 vertically coincides with a center of the magnet 62L2. The voice coil is positioned in such a manner as to be embedded in a center of an upper portion of the magnet 62L2.

The inner surface of the vibration element 62L1 is exposed from the upper surface 54L1. Specifically speaking, the open upper surface of the vibration element 62L1 is attached to a sound emission hole 54L1H which penetrates the upper surface 54L1 in the up-down direction. The sound emission hole 54L1H has the substantially same shape as that of the upper surface of the vibration element 62L1, which will be described later. The lower surface, the inner surface, and the outer surface of the vibration element 62L1, which lie below the upper surface thereof, are positioned inside the storage area 54LA. The speaker 62L receives an electric signal from the control circuit board 26L to emit a sound in the up-down direction from the vibration element 62L1.

As shown in FIG. 6A, the case fixing hole 48a, which penetrates the storage section 54L in the up-down direction, is provided in a lower back portion of the right side surface 54L2 of the storage section 54L. In other words, when viewed from above, the case fixing hole 48a is positioned on a left front side of the attachment hole 40LB.

As shown in FIGS. 4 to 6B, the acoustic section 56L has a box shape which is open in a right surface and a lower surface. A left back corner of the acoustic section 56L is chamfered at about 45 degrees. To describe this in greater detail, when viewed from above, the acoustic section 56L includes a substantially elongated rectangular upper surface 56L1 having a left short side, a front long side, and a back long side, a left side surface 56L2 extending in the downward direction from the left short side, a front side surface 56L3 extending in the downward direction from the front long side, and a back side surface 56L4 extending in the downward direction from the back long side. An open right surface is defined by right ends of the upper surface 56L1, the front side surface 56L3, and the back side surface 56L4. This open right surface connects to the open left surface of the storage section 54L. As a result, the upper surface 54L1 and the upper surface 56L1, the front side surface 54L3 and the front side surface 56L3, and the back side surface 54L4 and the back side surface 56L4 individually lie on the same plane.

The acoustic section 56L is rested to be fixed to the receiving frame 30L. To be more specific, lower ends of the left side surface 56L2, the front side surface 56L3, and the back side surface 56L4 are joined to the upper end of the receiving frame 30L. As a result, as shown in FIG. 9, the acoustic area 56LA, which extends in the left-right direction, is defined by being surrounded by the upper surface 56L1, the left side surface 56L2, the front side surface 56L3, and the back side surface 56L4 of the acoustic section 56L, as well as the receiving frame 30L. As a result, an acoustic space 56LS corresponding to the acoustic area 56LA is defined by the acoustic section 56L being rested on the receiving frame 30L. To describe this in greater detail, the acoustic area 56LA includes the lower bosses 44b, 44c. The acoustic area 56LA is positioned on a left side of an outer surface of a recess having the shape of a frustum of circular cone which tapers off downwards from the upper surface 56L1 in such a manner as to surround a left side of an outer surface of the lower boss 44b which has the shape of a frustum of circular cone which tapers off in the upper direction and the case fixing hole 48b. An elastic seal material is affixed to a joint plane between the lower ends of the left side surface 56L2, the front side surface 56L3 and the back side surface 56L4 and the upper end of the receiving frame 30. As a result, the acoustic area 56LA is tightly closed all around except for a surface through which the acoustic area 56LA communicates with the storage area 54LA positioned at a right end thereof.

In this way, the acoustic area 56LA and the duct 58L are positioned laterally symmetrically on either side of the storage area 54LA. The storage area 54LA and the acoustic area 56LA are connected to each other to define a single integrated communicating space. As a result, the acoustic area 56LA communicates with the outside of the lower case 16 via the storage area 54LA, the duct 58L, and the port 50L. In other words, the port 50L communicates with the acoustic area 56LA via the duct 58L and the storage area 54LA. Low notes or sounds emitted from the outer surface of the vibration element 62L1 are transmitted from the storage area 54LA to the acoustic area 56LA as indicated by a broken-line arrow shown in FIG. 9 and resonate in the acoustic area 56LA. Further, the low sounds which resonate in the acoustic area 56LA are transmitted from the storage area 54LA to the duct 58L and are then emitted in the downward direction from the port 50L. Here, rod-like ribs 66F1, 66F2, 66F3, which extend from an upper end to a lower end of the acoustic section 56L along a vertical axis, are disposed at equal intervals in the left-right direction on an inner surface of the front side surface 56L3. Rod-like ribs 66B1, 66B2, 66B3, which extend from the upper end to the lower end of the acoustic section 56L along the vertical axis, are disposed at equal intervals in the left-right direction on an inner surface of the back side surface 56L4.

The four attachment holes 42LF, 42LB, 42RF, 42RB are provided individually in four corners of the acoustic section 56L in such a manner as to penetrate the acoustic section 56L in the up-down direction. The attachment holes 42LF, 42LB, 42RF, 42RB are positioned respectively in a left front corner, a left back corner, a right front corner, and a right back corner of the acoustic section 56L. Attachment screws 36 are inserted into the attachment holes 42LF, 42LB, 42RF, 42RB from above to be brought into screw engagement with the standing holes 34LF, 34LB, 34RF, 34RB, which will be described later, provided in a leftward portion inside the receiving frame 30L. As a result, the acoustic section 56L is attached to the receiving frame 30L. To describe this in greater detail, a lower end of the acoustic section 56L is joined to an upper end of the leftward portion of the receiving frame 30L.

As shown in FIGS. 4 to 6B, the case fixing holes 48b, 48c are provided in a lower surface of a hollow part having the shape of a frustum of circular cone which tapers off in the downward direction from an inside of the upper surface 56L1 in such a manner as to penetrate the lower surface in the up-down direction. The case fixing holes 48b, 48c are positioned respectively in a right back portion and a left back portion of the acoustic section 56L. To describe this in greater detail, when viewed from above, the case fixing holes 48b, 48c are positioned in the vicinity of a left front side of the attachment hole 42RB and a left front side of the attachment hole 42LB respectively.

Subsequently, the operation and working effect of the sound emitting apparatus 28L will be described. In the configuration that has been described heretofore, when the player operates the keyboard 12, notes or sounds are emitted in the upward direction from the open upper surface of the vibration element 62L1 of the speaker 62L as indicated by a thick white arrow shown in FIG. 9. In addition, low notes or sounds are emitted from the outer surface of the speaker 62L as indicated by the broken-line arrow in FIG. 9 at the same time that the low sounds are emitted in the upward direction. The low sounds so emitted are transmitted to the acoustic area 56LA via the storage area 54LA. Then, the low sounds continue to be transmitted in such a way as to return to the storage area 54LA and are emitted to the outside of the lower case 16 from the port 50L by way of the duct 58L. In this way, the enriched low sounds are emitted outwards. Here, vibrations of air are emitted through the space defined between the lower main surface 16B2 of the lower case 16 and the resting surface without being interrupted.

According to the embodiment of the present disclosure, the acoustic area 56LA is provided in such a manner as to lie adjacent to a longitudinal outer side of the storage area 54LA where the speaker 62L is housed. As a result of this, the storage area 54LA does not have to hold a volume for performing an acoustic function for low notes or sounds. As a result, a length of the storage area 54L in the up-down direction can be suppressed to a length that can enable the storage of the speaker 62L. Further, the electronic keyboard instrument 1 can be made smaller in size by adjusting a length of the acoustic area 56LA in the up-down direction to that of the storage area 54LA while being expanded in the left-right direction. Specifically speaking, the electronic keyboard instrument 1 can be made smaller in thickness by reducing a length of the casing 10 in the up-down direction.

A resonating effect is produced by the structural configuration made up of the acoustic area 56LA, the duct 58L, and the port 50L. Specifically speaking, when notes or sounds are emitted in the upward direction from the speaker 62L in response to the operation of the keyboard 12 by the player, low notes or sounds which resonate in the acoustic area 56LA are emitted in the downward direction from the port 50L by way of the storage area 54LA and the duct 58L at the same time as the upward emission of the sounds, thereby enhancing the resonating effect. The low sounds emitted in the downward direction from the port 50L are in phase with the low sounds emitted in the upward direction from the speaker 62L. As a result, a phase difference-related interference is suppressed, whereby the low sounds are enriched. With the sound emitting apparatus 28L, the reproduction capability of low notes or sounds can be improved while making the casing 10 smaller in size (in thickness).

The acoustic area 56LA holds a sufficient volume as a result of being expanded in the left-right direction. Further, the storage area 54LA is interposed between the acoustic area 56LA and the port 50L, and this configuration functions to extend the distance between the acoustic area 56LA and the port 50L to thereby increase a flow path resistance from the acoustic area 56LA to the port 50L, whereby the elasticity of air passing through the port 50L is increased. This can provide a good resonating effect to thereby improve the reproduction capability of low notes or sounds. Further, as a result of the distance between the acoustic area 56LA and the port 50L being extended, the degree of freedom in adjusting the position of the port 50L is increased to the performance of the speaker 62L, thereby making it possible to improve the tone of a low note or sound.

The lower bosses 44a, 44b provided inside the receiving frame 30L are provided in the vicinity of the standing hole 32 LB, 34RB, respectively, while positioned in such a manner as to avoid the transverse central portion of the receiving frame 30L. This configuration makes it difficult for a communication between the acoustic area 56LA and the storage area 54LA to be interrupted, whereby vibrations of air are transmitted smoothly between the acoustic area 56LA and the storage area 54LA. This can improve the reproduction capability of low notes or sounds.

Thus, with the sound emitting apparatus 28L, the reproduction capability of low notes or sounds can be improved while making the electronic keyboard instrument 1 smaller in size (in thickness). In addition, the sound emitting apparatus 28R can also provide a similar operation and working effect to those of the sound emitting apparatus 28L. Further, the storage area 54LA does not serve a resonating function for low notes or sounds, and hence, the storage area 54LA is not influenced by a positional relationship with the port 50L. The speaker 62L to be housed can be provided in an appropriate position as a result of the degree of freedom in laying out the storage area 54LA being increased. This can improve the reproduction capability of not only low notes or sounds but also other sounds.

The port connecting section 52L, the storage section 54L, and the acoustic section 56L are integrally molded into a single unit to thereby make up the sound emitting element 28L1. The port connecting section 52L includes the surrounding wall 64, and by resting the port connecting section 52L on the receiving frame 30L, the lower end of the surrounding wall 64 is joined to the upper end of the duct rib 68, whereby the duct 58L is defined. That is, the part of the duct 58L is defined by the surrounding wall 64 which partially makes up the sound emitting element 28L1 and the duct rib 68 which partially makes up the lower case 16. Further, the duct 58L is made up of the surrounding wall 64 which partially makes up the sound emitting element 28L1 and the duct rib 68 which partially makes up the lower case 16. As a result, the production cost can be reduced more than a case in which the duct 58L is defined by a separate plate-shaped component.

The lower bosses 44a, 44b, 44c provided inside the receiving frame 30L are aligned on the longitudinal axis Ax. As a result, in the step of fixing the upper case 14, the sound emitting element 28L1, and the lower case 16 together into the single integrated unit with the fixing screws 46, the working person can insert to pass the fixing screws 46 through the lower bosses 44a, 44b, 44c, whereby the working efficiency can be improved. As a result, the production cost can be reduced.

Further, the multiple U-shaped grooves 16Bld extending in the left-right direction are provided in the upper main surface 16B1 inside the receiving frame 30L. As a result, vibrations of air traveling towards the port 50L inside the duct 58L can be transmitted smoothly, whereby the reproduction capability of low notes or sounds is improved.

The rod-shaped ribs 66F1, 66F2, 66F3, 66B1, 66B2, 66B3, which extend from the upper end to the lower end of the acoustic section 56L along the vertical axis, are disposed at the equal intervals on the respective inner surfaces of the front side surface 56L3 and the back side surface 56L4 of the acoustic section 56L. As a result, even with the acoustic section 56L which is expanded in the left-right direction, the deflection strength with respect to the up-down direction is increased to thereby obtain the stable resonating effect, whereby the reproduction capability of low notes or sounds is improved.

The control circuit board 26L is rested on the port connecting section 52L. As a result, the sound emitting apparatus 28L and the control circuit board 26L are integrated into a single unit to thereby improve the working efficiency in an assembling step of the electronic keyboard instrument 1, whereby the production cost can be reduced.

A lower note or sound is characterized by a greater diffraction than a higher note or sound, and hence, with a conventional sound emitting apparatus, a note or sound emitted from a sound emission hole diffracts, whereby a note or sound emitted from a back surface of a speaker interferes with a note or sound emitted from a front surface of the speaker, resulting in a problem in that a production of a low note or sound cannot be ensured completely. In contrast with this, with the embodiment of the present disclosure, the phase difference-related interference is suppressed, whereby an enriched low note or sound can be produced in an ensured fashion.

Here, the longitudinal positions of the port connecting section 52L and the acoustic section 56L may be interchanged with respect to the storage section 54L. The longitudinal positions of the port connecting section 52R and the acoustic section 56R may be interchanged with respect to the storage section 54R.

A resonating effect is produced by the structural configuration made up of the acoustic area 56LA, the duct 58L, and the port 50L. Specifically speaking, when notes or sounds are emitted in the upward direction from the speaker 62L in response to the operation of the keyboard 12 by the player, low notes or sounds which resonate in the acoustic area 56LA are emitted in the downward direction from the port 50L by way of the storage area 54LA and the duct 58L at the same time as the upward emission of the sounds, thereby enhancing the resonating effect. The low sounds emitted in the downward direction from the port 50L are in phase with the low sounds emitted in the upward direction from the speaker 62L. As a result, a phase difference-related interference is suppressed, whereby the low sounds are enriched. With the sound emitting apparatus 28L, the reproduction capability of low notes or sounds can be improved while making the casing 10 smaller in size (in thickness).

Here, the embodiment that has been described heretofore is presented as the example, and hence, there is no intention of limiting the scope of the present invention by the embodiment. The novel embodiment can be carried out in other various forms, and various omissions, replacements, and modifications can be made thereto without departing from the spirit and scope of the present invention. Those resulting embodiments and modified examples of the present invention are included in the scope and gist of the present invention and are also included in the scope of disclosures claimed for patent under claims below and their equivalents.

What is claimed is:

1. A sound emitting apparatus comprising:
a receiving frame in a shape of a box that is open at a top; and
a sound emitting element disposed on the receiving frame and formed integrally,
wherein the receiving frame and the sound emitting element together form a storage space for housing a speaker, an acoustic space connected to the storage space, and a duct connected to the storage space,
wherein the acoustic space constitutes a space corresponding to an area including multiple lower bosses configured to fix the receiving frame and the sound emitting element together, provided to be aligned in a left-right direction, and protruding in an upward direction, and
wherein the receiving frame comprises a port that is open at a position corresponding to the duct.

2. The sound emitting apparatus according to claim 1,
wherein the receiving frame comprises multiple standing holes protruding in the upward direction and the multiple lower bosses in an inside thereof,
wherein the multiple standing holes are positioned at a front end and a back end inside the receiving frame in such a manner as to constitute a pair along a transverse axis and are disposed at predetermined intervals in a left-right direction, and
wherein the multiple lower bosses are disposed near the multiple standing holes in such a manner as not to be brought into contact with the transverse axis.

3. The sound emitting apparatus according to claim 2,
wherein the multiple lower bosses are disposed at predetermined intervals along an identical longitudinal axis.

4. The sound emitting apparatus according to claim 1,
wherein a part of the duct is defined by a part of the sound emitting element.

5. The sound emitting apparatus according to claim 4,
wherein the sound emitting element comprises a surrounding wall protruding in a downward direction,
wherein the receiving frame comprises a duct rib protruding in the upward direction, and
wherein the duct is formed inside the receiving frame by joining a lower end of the surrounding wall and an upper end of the duct rib.

6. The sound emitting apparatus according to claim 5,
wherein a U-shaped groove extending in the left-right direction is provided in an upper main surface inside the receiving frame.

7. The sound emitting apparatus according to claim 6,
wherein a control circuit board configured to output a signal to the speaker is rested and is integrated with the sound emitting element.

8. The sound emitting apparatus according to claim 7,
wherein multiple ribs extending from an upper end to a lower end are disposed on respective inner surfaces of a front side surface and back side surface of a box-shaped acoustic section rested on the receiving frame to define the acoustic space.

9. An electronic keyboard instrument comprising the sound emitting apparatus according to claim 1.

10. An electronic keyboard instrument comprising the sound emitting apparatus according to claim 2.

11. An electronic keyboard instrument comprising the sound emitting apparatus according to claim 3.

12. An electronic keyboard instrument comprising the sound emitting apparatus according to claim 4.

13. An electronic keyboard instrument comprising the sound emitting apparatus according to claim 5.

14. An electronic keyboard instrument comprising the sound emitting apparatus according to claim 6.

15. An electronic keyboard instrument comprising the sound emitting apparatus according to claim 7.

16. An electronic keyboard instrument comprising the sound emitting apparatus according to claim 8.

17. The electronic keyboard instrument according to claim 9,
wherein the duct is positioned further inwards than the storage space, and the acoustic space is positioned further outwards than the storage space.
